(19) United States
(12) Patent Application Publication
(10) Pub. No.: US 2010/0187757 A1
(43) Pub. Date: Jul. 29, 2010

(54) WEIGHTED GAMING CHIP AND METHOD OF PRODUCING A CHIP OF THIS TYPE

(76) Inventors: Pierre CHAPET, Beaune (FR); Christophe LEPAROUX, Beaune (FR)

Correspondence Address: Hershkovitz & Associates, LLC, 2845 Duke Street, Alexandria, VA, 22314, US

(21) Appl. No.: 12/363,586

(22) Filed: Jan. 30, 2009

(30) Foreign Application Priority Data
Jan. 23, 2009 (FR) 09 50429

(51) Int. Cl. A63B 71/00; B29C 45/14

(52) U.S. Cl. 273/148 R; 264/277

(57) ABSTRACT

The invention relates in particular to a gaming chip comprising a weighting disc (3), the dimensions of which are smaller than those of the chip, the weighting disc (3) being embedded in the thickness of said chip. The chip is notable in that it comprises a continuous ring (5) which is formed from a transparent material, extends through the thickness of the chip and surrounds the weighting disc (3) as closely as possible.

### CROSS-REFERENCE TO RELATED APPLICATIONS

The present application claims priority under 35 USC §1.119 of French Patent Application No. 09 50429 filed on Jan. 23, 2009, the disclosure of which is expressly incorporated herein by reference in its entirety.

### SPECIFICATION

The present invention relates to a gaming chip of the type comprising a weighting disc, the dimensions of which are smaller than those of the chip, the weighting disc being embedded in the thickness of said chip.

Chips of this type are described in particular in the patent application FR 2 656 538.

The chips are formed from a synthetic material which is not sufficient to provide the chip with the required weight alone.

Chip weight is an important aspect for the croupiers who handle them. For example, the weight of said chips is generally approximately 12 to 15 g for cylindrical chips. Chip weights which are lower or greater than the range to which the croupier is accustomed have a detrimental effect on the croupier's ability to handle them.

A first solution to this problem is to insert (or embed) a metal weight in the form of a disc into the chip.

A second solution is to mix the chip material with densifying particles, i.e. particles which have a greater density than those of this material in order to obtain a heavier material which is referred to by those skilled in the art as “filled material”.

A third solution is to produce a chip comprising both a weighting disc and a filled material. A chip of this type is described in the patent application FR 2 656 538.

For counterfeiters wishing to produce counterfeit chips with the same weight as genuine chips in a casino, it is easier to insert weighting discs into chips than to produce chips using a filled material, which is difficult to purchase commercially.

In addition, in order to forge authentic chips which comprise both a weighting disc and a material filled with densifying particles, the counterfeiters increase the size of the weighting discs in the chips, the weighting discs being embedded in a non-filled material which can easily be purchased commercially.

The chips obtained in this way have a weight which is similar to those which are conventionally handled by croupiers so it is difficult to distinguish counterfeit chips by handling them if their outer appearance does not indicate their counterfeit origins.

The object of the invention is to provide weighted chips, the authenticity of which can be easily confirmed.

For this purpose, the invention relates to a chip of the aforementioned type which is notable in that it comprises a continuous ring made of a transparent material which extends over the thickness of the chip and surrounds the weighting disc of the chip as closely as possible.

A croupier can easily confirm that a weighting disc is the same size as that of a genuine chip in a single glance due to the transparency of the ring which passes through the thickness of the chip and completely surrounds the weighting disc.

In this way, a person with illegal intentions producing weighted chips is no longer able to increase the size of the weighting discs in the chips as a substitute for the material filled with metal particles, thus making the process of counterfeiting the chips more difficult. It should also be noted that in genuine chips the weighting discs are generally barely thinner than the chip, which prevents the weight of the chip from being increased by increasing the thickness of the disc.

The chip according to the invention also comprises the following features taken alone or in combination:
said ring has a thickness which is substantially equal to the thickness of the chip;
said ring comprises means for attaching a decorative element;
said attachment means comprise radial fingers which project from the edge of said ring;
the decorative element covers said radial fingers;
the decorative element is obtained by injection-moulding material;
the decorative element is produced from a material weighted by particles;
the decorative element is produced from an opaque material;
the decorative element comprises portions which are in relief;
said injection-moulded ring comprises radial notches formed in the edge thereof, said notches being positioned angularly between two portions which are in relief;
it comprises a layer of material which is injection-moulded on the decorative element, the surface of which is level with the surface of the portions in relief.

The invention also relates to a method of producing chips of this type.

In particular, the object of the method according to the invention is the production of a chip comprising a weighting disc, the dimensions of which are smaller than those of the chip, which is notable in that it comprises the following steps:
arranging the weighting disc in a mould,
injection-moulding a continuous ring made of a transparent material around the weighting disc.

The method according to the invention also comprises the following steps, taken alone or in combination:
arranging the weighting disc in a mould;
injection-moulding a continuous ring made of a transparent material around said weighting disc;
it comprises a second injection-moulding step to provide a decorative element around said ring;
the injection-moulded decorative element comprises portions which are in relief, and the injection-moulded ring comprises radial notches which result from the weighting disc being supported by the edge thereof during said first injection-moulding process, said second injection-moulding step being carried out in the following manner:
arranging an assembly comprising the weighting disc surrounded by said ring made of transparent material in a second mould in such a way that said notches are positioned angularly between two impressions which are produced in said second mould and are intended to form two of said portions in relief of said decorative element;
injection-moulding material in said second mould to form the decorative element.

A clearer understanding of the invention will be facilitated by the following description of embodiments with reference to the appended drawings, in which:

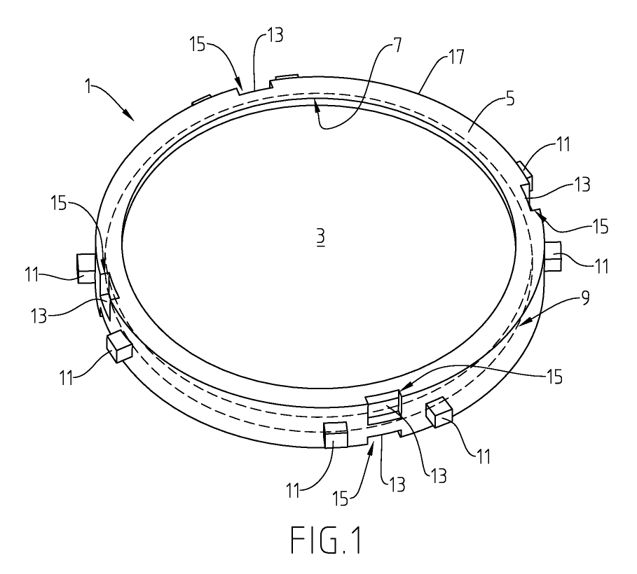

FIG. 1 is a perspective view of a first assembly which comprises a weighting disc and a ring and is obtained after a first step of injection-moulding transparent material around said weighting disc,

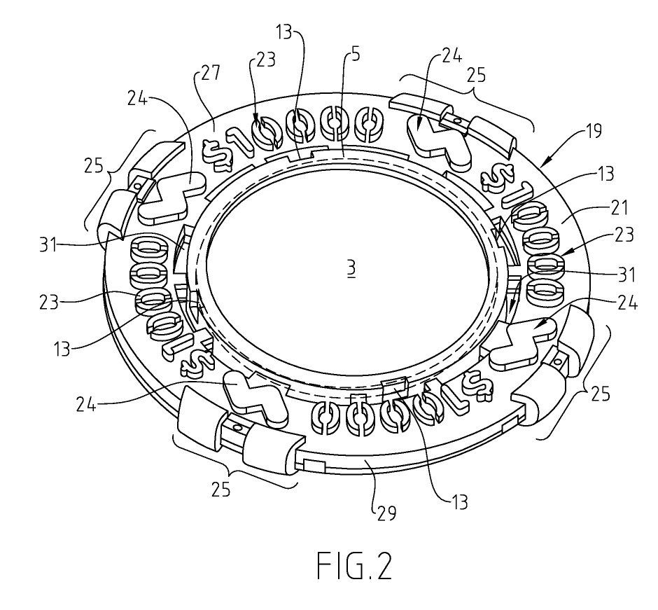

FIG. 2 is a perspective view of a second assembly which comprises the first assembly shown in FIG. 1 and a decorative element obtained after a second step of injection-moulding a filled material around said first assembly, and

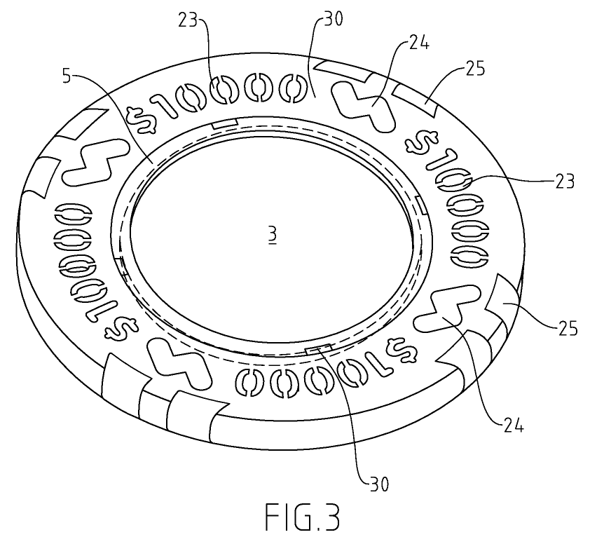

FIG. 3 is a perspective view of a chip obtained after a third step of injection-moulding a layer of decorative material on the second assembly shown in FIG. 2.

FIG. 1 shows a first part 1 of the chip obtained after a first step of producing a chip according to the invention.

The first part of the chip comprises a weighting disc 3 which is cylindrical and substantially planar.

The weighting disc 3 is made of metal or a heavy metal alloy such as brass.

In another embodiment which is not described but would also be in accordance with the invention the weighting disc 3 may also be produced in the form of a disc comprising an electronic chip which is coated in resin, the resin/chip assembly being embedded in a plastics material filled with densifying particles such as tungsten particles.

The first part 1 of the chip also comprises a ring 5 which surrounds the weighting disc 3 around the edge thereof as closely as possible.

The ring 5 is formed from a transparent material such as a transparent plastics material.

The ring 5 is circular and continuous, i.e. it completely surrounds the edge of the weighting disc 3 without being truncated in the vicinity of the edge of the weighting disc 3.

The edge of the weighting disc is thus completely visible through the ring 5.

In order to remain arranged against the weighting disc 3, the ring 5 encloses the weighting disc 3 between two inner rims 7, each rim 7 projecting over a face of the weighting disc 3.

The thickness of the ring 5 is substantially equal to the final thickness of the chip.

On its edge 9, the ring 5 comprises means 11 for attaching a decorative element shown in FIG. 2.

These attachment means are in the form of radial fingers 11 which project from the edge of the ring 5.

The fingers 11 are substantially parallelepiped-shaped.

The fingers 11 are distributed uniformly in groups of two about the axis of the ring 5.

The ring 5 also comprises radial notches 13 which are formed at regular intervals about the axis of said ring 5.

The radial notches 13 are arranged in pairs and are formed in part in the edge of said ring 5 between two fingers 11 in a group of two fingers 11. The notches 13 of a pair of notches are aligned axially and separated from one another by a portion of the ring 5, of which the thickness is reduced but the diameter is the same as the rest of the ring.

Each of the radial notches 13 represents a partial truncation 15 of an edge 17 of the ring 5 for reasons which shall be explained below.

The first part 1 of the chip currently being described is produced as follows:

In a first stage, the weighting disc 3 is arranged in a mould and is held in place by supporting fingers (not shown) which are distributed around the weighting disc 3 and which abut the edge of the weighting disc 3.

The transparent plastics material is injection-moulded around the weighting disc 3 in the mould to form the ring 5.

The fingers for supporting the weighting disc are then withdrawn from the mould before the first part 1 of the chip thus obtained is removed from the mould.

The withdrawal of the supporting fingers thus leaves impressions which form the notches 13 in the ring 5.

FIG. 2 shows a second part 19 of the chip which is obtained after a second step in the production of a chip according to the invention.

The second part 19 of the chip is formed from the first part 1 of the chip and a decorative element 21. The decorative element 21 is in the form of a flattened ring which surrounds the ring 5 and is connected thereto by the attachment fingers 11.

The decorative element 21 is thinner than the ring 5 with the exception of the decorative portions thereof which are described below.

The decorative element 21 is obtained by a second step of injection-moulding a second material around the ring 5. The second material is preferably not transparent. The second material is an opaque material which is filled with material liable to increase the weight thereof such as clay or barium sulphate particles, metal particles or any other densifying particles.

By way of example, the transparent plastics material used to form the ring has a density of 1 whereas the second material used to form the decorative element 21 has a density of 2.34.

As shown in FIG. 2, the decorative element 21 has elements 23, 24 and 25 which are in relief.

The elements 23 and 24 in relief are formed on one of the two substantially planar opposing faces 27 of the annular decorative elements 21 and form, for example, elements 23 indicating the value represented by the chip and decorative elements 24.

The elements 25 in relief are formed on the edge 29 of the decorative elements 21 and extend in part over the substantially planar opposing surfaces 27. The elements 25 in relief form, for example, elements indicating the value of the chip for a croupier assigned to handle them, the number of elements 25 in relief which are formed on the edge of the chip matching the value attributed to the chip for example.

The elements 23 and 24 in relief on the one hand and the element 25 in relief on the other are of such a thickness that they are level with the lateral surface(s) and with the edge of the finished chip respectively.

In order to form the decorative element 21, the first part 1 of the chip is arranged in a second mould in such a way that the notches 13 are positioned angularly symmetrically between two consecutive peripheral impressions formed in the second mould in order to produce two elements 25 which are in relief on the edge of the decorative element 21. The projecting fingers 11 are received in complementary recesses (not shown) of the second mould in order to ensure the angular position of said notches.

In fact, as will be explained below, the notches 13 will be filled with a layer of material 30 in order to form visible markings which visually break up the surface of the transparent ring 5 on the chip, said transparent ring not being interrupted between two axially aligned layers.

Therefore, by positioning the first part of the chip in the second mould in a particular manner, the markings are always arranged angularly in the same manner in relation to the decorative elements 25 on all the genuine chips in such a way that the positioning thereof represents an additional marker providing a visual indication to a croupier that the chip is a genuine chip.

It is also provided that empty gaps 31 in the form of annular sectors are left between the annular decorative elements 21 and the ring 5 in such a way that the covering layer 30, which is injection-moulded in the third step in the production of the chip, covers the depth of the chip.

The layer 30 is thus more solid and this makes the destruction thereof difficult.

The covering layer 30 which is injection-moulded in a third step is opaque, and is preferably a colour which is different from that of the filled material from which the decorative element 21 is formed in such a way that the elements 23, 24 and 25 in relief, which are level with the surface of the finished chip, are visible (see FIG. 3).

In order to form the layer 30, the second part 19 of the chip, which is obtained after injection-moulding the filled material on the first part 1 of the chip, is arranged in a third mould.

The third mould has an impression, the depth of which is substantially equal to that of the final chip, and therefore substantially equal to the thickness of the ring 5.

The second part 19 of the chip is held in the third mould by the filled disc 3 or by the ring 5 in such a way that the injection-moulded layer 30 does not show any indication of having been held when the chip is removed from the mould.

The layer 30 is injection-moulded in such a way that the layer 30 does not cover the ring 5. The ring 5 therefore remains completely visible.

Since the third mould has an impression with a depth which is substantially equal to that of the final chip, the surface of the layer 30 is level with the surface of the portions 23, 24 and 25 in relief.

The weighting disc 3, which is slightly thinner than the ring 5, may also be covered by an adhesive decorative element, provided that this decorative element does not cover the transparent ring 5.

The thickness of the ring 5 is substantially equal to that of the finished chip and therefore extends through the thickness of the chip. It is thus possible to verify that the chip does not have a weighting disc with a greater surface area than those in genuine chips which would pass through the ring. The transparent ring 5 is continuous and not interrupted visually except by the markings formed by the layers 30.

The description above has shown how the invention enables the authenticity of a weighted chip to be verified easily.

It should, however, be understood that the invention is not limited to the specific embodiment described and any equivalent means are included in the scope of the invention.

In particular, the ring and the weighting disc may have different, non-circular shapes such as a rectangle, flower, star or ellipse without departing from the scope of the invention.

1. Gaming chip comprising a weighting disc (3), the dimensions of which are smaller than those of the chip, the weighting disc (3) being embedded in the thickness of said chip, characterised in that it comprises a continuous ring (5) which is formed from a transparent material, extends through the thickness of the chip and surrounds the weighting disc (3) of the chip as closely as possible.

2. Chip according to claim one, characterised in that said ring (5) has a thickness which is substantially equal to the thickness of the chip.

3. Chip according to either claim 1 or claim 2, characterised in that said ring (5) comprises means (11) for attaching a decorative element (21).

4. Chip according to claim 3, characterised in that said attachment means comprise radial fingers (11) which project from the edge (9) of said ring.

5. Chip according to claim 4, characterised in that the decorative element (21) covers said radial fingers (11).

6. Chip according to any one of claims 3 to 5, characterised in that the decorative element (21) is obtained by injection-moulding material.

7. Chip according to any one of claims 3 to 6, characterised in that the decorative element (21) is produced from a material weighted by particles.

8. Chip according to any one of claims 3 to 7, characterised in that the decorative element (21) is produced from an opaque material.

9. Chip according to any one of claims 3 to 8, characterised in that the decorative element (21) comprises portions which are in relief (23, 24, 25).

10. Chip according to claim 9, characterised in that said injection-moulded ring (5) comprises radial notches (13) formed in the edge thereof, said notches (13) being positioned angularly between two portions (25) which are in relief.

11. Chip according to claim 10, characterised in that it comprises a layer (30) of material which is injection-moulded on the decorative element (21), the surface of which is level with the surface of the portions in relief (23, 24, 25).

12. Chip according to any one of claims 1 to 11, characterised in that said weighting disc (3) and said transparent ring (5) are circular.

13. Method of producing a chip comprising a weighting disc (3), the dimensions of which are smaller than those of the chip, which is notable in that it comprises the following steps:
arranging the weighting disc (3) in a mould,
injection-moulding a continuous ring (5) made of a transparent material around the weighting disc (3).

14. Production method according to claim 13, characterised in that it comprises a second injection-moulding step to provide a decorative element (21) around said ring (5).

15. Production method according to claim 14, characterised in that the injection-moulding moulded decorative element (21) comprises portions (23, 24, 25) which are in relief, and in that the injection-moulded ring (5) comprises radial notches (13) which result from the weighting disc (3) being supported by the edge thereof during said first injection-moulding process, said second injection-moulding step being carried out in the following manner:
arranging an assembly (1) comprising the weighting disc (3) surrounded by said ring (5) made of transparent material in a second mould in such a way that said notches (13) are positioned angularly between two impressions which are produced in said second mould and are intended to form two of said portions (25) in relief of said decorative element (21),
injection-moulding material in said second mould to form the decorative element (21).

16. Method according to claim 15, characterised in that it comprises a third step of injection-moulding material over an assembly (19) comprising said weighting disc (3), said ring (5) obtained after said first injection-moulding process in said first mould and said decorative element (21) obtained after said second injection-moulding process in said second mould, said third injection-moulding step being carried out in a third mould, the impression of which has a depth which is substantially equal to the depth of said ring (5).
